(19) United States
(12) Patent Application Publication
(10) Pub. No.: US 2026/0303617 A1
(43) Pub. Date: Oct. 1, 2026

(54) METHOD AND SYSTEM FOR CHARACTERIZING A DENIAL OF SERVICE (DOS) ATTACK FOR EFFECTIVE MITIGATION

(71) Applicant: Radware Ltd., Tel Aviv (IL)

(72) Inventor: Avi CHESLA, Tel Aviv (IL)

(73) Assignee: Radware Ltd., Tel Aviv (IL)

(21) Appl. No.: 19/092,546

(22) Filed: Mar. 27, 2025

(51) Int. Cl. H04L 9/40

(52) U.S. Cl. CPC H04L 63/1416; H04L 63/1458

(57) ABSTRACT

A method and system for efficiently characterizing an incoming cybersecurity attack is provided. The method includes extracting traffic parameters from collected telemetry data of the attack, wherein the traffic parameters include a plurality of footprint types and associated footprint values; characterizing the attack by a behavioral analysis of the traffic parameters in order to determine behavioral data for the plurality of footprint types and an attack pattern for the attack, wherein the behavioral data has an intensity scale for each footprint type of the plurality of footprint types with respect to an attack rate; determining, based on the attack pattern and the behavioral data, a priority list of the plurality of footprint types; and generating a real-time signature (RTS) for mitigation, wherein the RTS has a target footprint type selected according to the priority list.

### TECHNICAL FIELD

The present disclosure relates generally to the tackling of malicious cyberattacks and, more specifically, to the efficient characterization and mitigation of a denial of service (DoS) attack based on behavioral analysis.

### BACKGROUND

Denial of service (DoS) and distributed denial of service (DDoS) attacks are types of cyberattacks where attackers overload a target computer, a network infrastructure, a server, or a system with access requests, to the point where the target computer becomes unable to fulfill its intended purpose.

DoS/DDoS attacks (hereinafter collectively referred to as DDoS attacks) can potentially be performed on the network layer, e.g., using the TCP/UDP/Internet Protocol (IP) layer, or on various application layers, e.g., using HTTP/S layer. Some examples of DDoS attacks include, without limitation, SYN flood, UDP flood, ICMP flood, amplification attacks, Smurf attack, and more which flood and exhaust system resources. These DDoS attacks can be launched at high volume. In some cases, the DDoS attack can also target network services' and application's memory and compute resources without requiring a high attack rate. Additionally, such attacks often use randomized or highly varied attack identities that display subtle anomalies without distinctive attack patterns.

Further, modern attack tools have evolved to generate transactions that mimic normal traffic patterns to evade detection and mitigation methods. To achieve this, attackers may comply with the protocols' request for comments (RFCs), randomize the values within the protocol headers and/or content of requests, and, when generating application-based DDoS attacks, use web client engines that can respond to web challenges. These deceptive techniques make existing DDoS detection and mitigation methods ineffective as they rely on finding consistent attack patterns and/or challenge-response verification methods.

In addition, a DDoS attack can use adaptive techniques to change attack vectors, alter traffic patterns mid-attack, or implement a mixture of attacks. Facing these attacks by leveraging prior knowledge and threat intelligence is ineffective. Thus, ongoing monitoring and protection are needed.

Accordingly, an efficient method and system for mitigating DDoS attacks is desired.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the terms “some embodiments” or “certain embodiments” or “one aspect” or “some aspects” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Certain embodiments disclosed herein include a method for efficiently characterizing an incoming cybersecurity attack. The method comprises: extracting traffic parameters from collected telemetry data of the attack, wherein the traffic parameters include a plurality of footprint types and associated footprint values; characterizing the attack by a behavioral analysis of the traffic parameters in order to determine behavioral data for the plurality of footprint types and an attack pattern for the attack, wherein the behavioral data has an intensity scale for each footprint type of the plurality of footprint types with respect to an attack rate; determining, based on the attack pattern and the behavioral data, a priority list of the plurality of footprint types; and generating a real-time signature (RTS) for mitigation, wherein the RTS has a target footprint type selected according to the priority list.

Certain embodiments disclosed herein also include a non-transitory computer readable medium having stored thereon causing a processing circuitry to execute a process, the process comprising: extracting traffic parameters from collected telemetry data of the attack, wherein the traffic parameters include a plurality of footprint types and associated footprint values; characterizing the attack by a behavioral analysis of the traffic parameters in order to determine behavioral data for the plurality of footprint types and an attack pattern for the attack, wherein the behavioral data has an intensity scale for each footprint type of the plurality of footprint types with respect to an attack rate; determining, based on the attack pattern and the behavioral data, a priority list of the plurality of footprint types; and generating a real-time signature (RTS) for mitigation, wherein the RTS has a target footprint type selected according to the priority list.

Certain embodiments disclosed herein also include a system for efficiently characterizing an incoming cybersecurity attack. The system comprises: a processing circuitry; and a memory, the memory containing instructions that, when executed by the processing circuitry, configure the system to: extract traffic parameters from collected telemetry data of the attack, wherein the traffic parameters include a plurality of footprint types and associated footprint values; characterize the attack by a behavioral analysis of the traffic parameters in order to determine behavioral data for the plurality of footprint types and an attack pattern for the attack, wherein the behavioral data has an intensity scale for each footprint type of the plurality of footprint types with respect to an attack rate; determine, based on the attack pattern and the behavioral data, a priority list of the plurality of footprint types; and generate a real-time signature (RTS) for mitigation, wherein the RTS has a target footprint type selected according to the priority list.

Certain embodiments disclosed herein include the method, non-transitory computer readable medium, or system noted above or below, further including or being configured to perform the following step or steps: executing a mitigation action for the attack based on the generated RTS.

Certain embodiments disclosed herein include the method, non-transitory computer-readable medium, or system noted above or below, further including or being configured to perform the following step or steps: classifying the attack as the attack pattern based on the determined intensity scales for the plurality of footprint types and a plurality of rules.

Certain embodiments disclosed herein include the method, non-transitory computer-readable medium, or system noted above or below, wherein the attack pattern is any one of: an overlap pattern, a partial overlap pattern, a no overlap pattern, and a fully randomized pattern.

Certain embodiments disclosed herein include the method, non-transitory computer readable medium, or system noted above or below, further including or being configured to perform the following step or steps: retrieving a peacetime behavioral data, wherein the peacetime behavioral data is the behavioral data determined from telemetry data during peacetime, wherein the peacetime behavioral data provides a verification status and a distribution of the footprint values within each footprint type.

Certain embodiments disclosed herein include the method, non-transitory computer-readable medium, or system noted above or below, further including or being configured to perform the following step or steps: determining a priority score for each of the plurality of footprint types, wherein the priority score is determined based on the peacetime behavioral data of each footprint types; grouping the plurality of footprint types by a predefined list of footprint type groups; and sorting the plurality of footprint types within the group by the respective priority scores.

Certain embodiments disclosed herein include the method, non-transitory computer-readable medium, or system noted above or below, further including or being configured to perform the following step or steps: sorting the plurality of footprint types by the intensity scale of each footprint type within the grouping.

Certain embodiments disclosed herein include the method, non-transitory computer-readable medium, or system noted above or below further including or being configured to perform the following step or steps: identifying a verified footprint value from the footprint values within the footprint type of the plurality of footprint types, wherein the verified footprint value has a verification score above a predefined verification threshold value; and generating a subset of footprint values for the footprint type that is missing the identified verified footprint value, wherein the subset of footprint values is utilized to determine a verification status and the priority list.

Certain embodiments disclosed herein include the method, non-transitory computer readable medium, or system noted above or below, wherein the mitigation action is executed in real-time for the incoming attack.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic network diagram utilized to describe various disclosed embodiments.

FIG. 2 are schematic diagrams illustrating example network traffic cases for various denial of service (DoS) attack pattern categories.

FIG. 3 is a flowchart illustrating a method for characterizing and mitigating a DoS network attack according to an embodiment.

FIG. 4 is an illustration of an influence matrix according to an example embodiment.

FIG. 5 is a flowchart illustrating a method for attack characterization by applying a behavioral analysis according to an embodiment.

FIG. 6 is a schematic diagram of a defense system according to an embodiment.

### DETAILED DESCRIPTION

It is important to note that the embodiments disclosed herein are only examples of the many advantageous uses of the innovative teachings. In general, statements made in the specification of the present application do not necessarily limit any of the various claimed embodiments. Moreover, some statements may apply to some inventive features but not others. In general, unless otherwise indicated, singular elements may be in plural and vice versa with no loss of generality. In the drawings, like numerals refer to like parts through several views.

The various disclosed embodiments include a method and system for characterizing and mitigating network layer cybersecurity attacks based on efficient behavioral analysis of telemetry data. The disclosed embodiments may be utilized to characterize a complex, high volume cybersecurity attack by extracting traffic parameters during peacetime and attack time telemetry data. A behavioral analysis is performed on the telemetry data that are detected and collected within the network infrastructure in real-time or near real-time, thereby enabling real-time characterization and mitigation of the cybersecurity attack. The disclosed embodiments determine an attack pattern for the attack and prioritize traffic parameters for accurate and efficient identification of target traffic parameters that are closely relevant to the attack. That is, the disclosed embodiments provide insights into the attack to demystify the complex attack of certain characteristics which may be used for attack mitigation.

The cybersecurity attack may be launched using attack techniques such as, but not limited to, denial of service (DoS), distributed denial of service (DDoS) attacks (herein used interchangeably), and the like. The network layer attack may be based on any communication protocols such as, but not limited to, transmission control protocol (TCP), user datagram protocol (UDP), and the like, and any combination thereof. The network layer DDoS attack attempts to flood the target's network infrastructure with excessive amounts of traffic to disrupt normal operation of the network resources. Such an attack is often indistinguishable from a legitimate traffic with typical (or normal) rate variations within the network traffic due to its random distributions, in attack patterns, sources (e.g., distributed, spoofed, etc.), packet sizes, Layer 4 (L4) port numbers, checksum values, and the like. Furthermore, the sheer volume of traffic causes increased computational burden for analyzing and characterizing the attack traffic.

The embodiments disclosed herein efficiently characterize the cybersecurity attack based on traffic parameters such as footprint types and associated footprint values of the attack that are extracted from network telemetry data. The types of footprints for an attack may include, for example, but not limited to, source IP, destination IP, TTL, packet size, source port, destination port and the like derived from intercommunications of layers 3 and 4 of Open System Interconnection (OSI) network.

The characterization of the attack may include, for example, but not limited to behavioral data, an influence matrix, an attack pattern category, target footprint types, and the like, and any combination thereof. It should be noted that the characterization identifies and isolates relevant malicious footprint types from normal or legitimate traffic that are challenging to detect in the high volume DDoS attacks that are random and perhaps evolving in attack patterns.

According to the disclosed embodiments, footprint types and their values of the detected attack may be extracted readily from the network telemetry data and analyzed without large computational overhead. Cybersecurity attacks, such as DoS, can be overwhelming to the network, the system, the infrastructure, and the like. Thus, complex attack detection and analysis that add additional burden on the already overwhelmed system may be problematic. The embodiments disclosed herein utilize the footprint types and their values to effectively determine behavioral data, classify the detected attack into a predefined attack pattern category, and identify target footprint types and values associated with the attack. The pattern category provides a guideline and criteria for target identification using certain traffic parameters, thereby eliminating extensive processing of all traffic parameters of the detected attack. To this end, processing load and memory usage are minimized to reduce computational overload at the defense system.

It should be noted that such conservation of resources is important in defense systems against cybersecurity attacks for effective detection, characterization, and mitigation. It should be further noted that such rapid and efficient characterization is critical for real-time or near real-time characterization and mitigation of on-going attacks.

According to the disclosed embodiments, a behavioral analysis is performed on peacetime traffic parameters and on at least some of the traffic parameters detected during attack time to determine behavioral data for the detected attack during peacetime and attack time. The peacetime behavioral data such as, but not limited to, a distribution of footprint types (e.g., theoretical distribution, actual distribution, deviation of distributions, etc.), a verification status, and the like, are determined during peacetime during low traffic periods when an attack is not detected. The peacetime traffic may be analyzed with sampled data within peacetime with low computational power. Moreover, the peacetime behavioral data that represent peacetime normal traffic behavior is common to traffic within a predefined time period. Thus, such peacetime behavioral data may be stored and reused to characterize multiple detected attacks within the predefined time period without repeated analysis, thereby conserving resources. It should be noted that the behavioral analysis may be performed continuously, regularly, intermittently, and in any combination thereof as the network traffic is detected within the infrastructure. That is, the analysis for characterization and mitigation may be triggered automatically, thereby allowing real-time or near real-time handling of the cybersecurity attack.

Furthermore, the embodiments disclosed herein increase accuracy (reduce false negative), reduce mean time to mitigate (MTTM), mean time to respond (MTTR), mean time to recovery, and the like by characterizing and generating a real-time signature (RTS) of the detected attack. The RTS includes target traffic parameters (e.g., footprint types, footprint value, etc.) selected based on the characterization of the detected attack. Rather than blindly handling the cybersecurity attacks using bulk blocking or based on static targets using whitelist, blacklist, and the like, that may be outdated, the RTS enables accurate and focused mitigation of footprint values that are identified to be associated with the detected attack. Moreover, the RTS identifies footprint values that have a greater impact or role in the detected attack based on the behavioral data, thereby further improving the accuracy and efficiency of starting to mitigate and the mitigation itself. It should be further noted that the RTS enables accurate distinguishing of the attack traffic parameters from legitimate traffic parameters in order to tackle the attack without disrupting the legitimate traffic (i.e., reduced false positives).

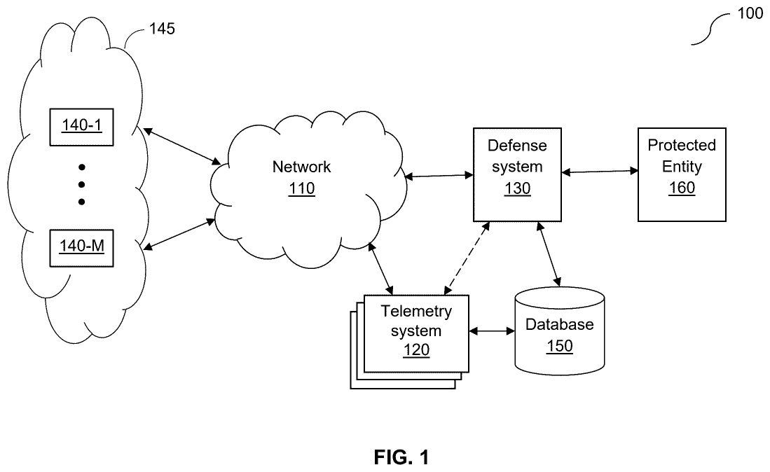

FIG. 1 is a schematic network diagram 100 explaining an environment for detecting, characterizing, and mitigating denial of service (DoS) attacks according to an embodiment. In the example network diagram 100, a plurality of attacker devices 140-1 through 140-M, one or more telemetry system 120, a defense system 130, a database 150, and a protected entity 160 communicate via a network 110. The network 110 may be, but is not limited to, a wireless, cellular, or wired network, a local area network (LAN), a wide area network (WAN), a metro area network (MAN), the Internet, the world wide web (WWW), similar networks, and any combination thereof.

The plurality of attacker devices 140-1 through 140-M (hereinafter referred to individually as an attacker device 140 and collectively as attacker devices 140 merely for simplicity, wherein M is an integer greater than 1) are network-connected computing devices, systems, software or the like, that are employed by a malicious entity to launch network attacks such as, but not limited to, denial of service (DoS), or the like, on a target service, system, or infrastructure. The attacker device 140 may utilize an attack tool to send a high volume of traffic and/or malformed packets to overwhelm the victim protected entity 160. Some examples of DoS attacks on the network layers include, without limitation, SYN flood, UDP flood, ping of death, and more.

In some cases, the attacker devices 140 may be accessed and employed as part of a botnet 145. The attacker devices 140 are infected with malicious software or scripts under the control of a malicious entity, often without consent and awareness. The attacker devices may include any devices such as, but are not limited to, personal computers, smartphones, tablets, Internet of Things (IoT) devices, routers, modems, printers, scanners, surveillance cameras, home appliances, and the like that have a connection to the network 110. Some other examples of the devices may include network connected microwaves, audio speakers, home security cameras, thermostats, smart locks, smart doorbells, and the like that lack advanced security features and are often easily compromised by a malicious entity. It should be noted that a single botnet 145 is shown for illustrative purposes and does not limit the scope of the disclosed embodiments. It should be further noted that devices apart from the botnet 145 (i.e., legitimate devices) may also be communicatively connected to the various components shown in the example network diagram 100.

The malicious entity may infect a large group of attacker devices 140, as part of the botnet 145, which may be leveraged to launch massive malicious attacks (i.e., botnet attacks) via tactics such as, but not limited to, initial access, persistence, credential access, impact, defense evasion, exfiltration, and the like, and more. Some techniques employed for accomplishing these adversarial tactics may include, for example, but not limited to, Distributed Denial-of-Service (DDoS) attacks, phishing campaigns, cryptojacking, credential stuffing attacks, data theft, ransomware distribution, and the like, and any combination thereof. As part of the botnet 145, the attacker devices 140 are configured to send network packets to potential attack targets connected through the network 110 including, but not limited to, one or more telemetry systems 120, the defense system 130, and the protected entity 160. The devices that are leveraged as a member of the botnet may be referred to as a botnet device or a botnet attacker.

The telemetry system 120 is, for example, a component, a server, or the like that is deployed with respect to the protected entity to gather telemetry data about performance, security, health, and the like, of the protected entity and/or the network environment. Multiple telemetry systems 120 may be strategically distributed, for example, but not limited to, within the protected network, at a network perimeter between internal and external networks, in the cloud, on endpoint devices, on security devices, and the like. Some examples of the telemetry system 120 include, but are not limited to, a detection tool or system, firewalls, cloud resource, IoT device, network sensors, network analytics platform, routers, Security Information and Event Management (SIEM) systems, and more. The telemetry system 120 is configured to continuously monitor the network of the protected entity 160 during peacetime, attack period, or both.

The telemetry system 120 is configured to collect and relay telemetry data to the defense system 130 over the network and/or directly, depending on the configuration. In some configurations, the telemetry system 120 stores the telemetry data at the database 150, which may be accessed by the defense system 130. The telemetry system 120 may be configured to collect telemetry data in the network environment continuously, periodically, intermittently, or both during peacetime. The network telemetry data may include, for example, but is not limited to, packet counts, traffic volumes, traffic patterns, source and destination internet protocols (IPs), protocol types, port numbers, and the like, and any combination thereof. In an embodiment, the transmittance of gathered data to the defense system 130 may be performed continuously, intermittently, or both. In some embodiments, the telemetry data and/or behavioral data are transmitted periodically at predefined time intervals, at predefined times, upon detecting a trigger event, and the like, and any combination thereof.

The defense system 130 is a node, a component, a system, a server, or any other facilitator(s) configured to detect, characterize, and mitigate the cybersecurity attacks (e.g., DoS, DDoS, anomalous traffic, and more) over the network 110. In an embodiment, the defense system 130 is deployed in-line with the protected entity 160 to observe and collect all inbound traffic data to the protected entity 160. That is, the defense system 130 sees real-time network traffic (e.g., packets, protocols, etc.) transmitted toward the protected entity 160 and its network infrastructure. The cybersecurity attack may target the network layers, for example, layers 3, 4, 5, and any combination thereof, of the OSI layer model. In some cases, the attack may target other layers or a combination of layers of the OSI layer model. Such cybersecurity attacks may be realized as distributed attacks with varied and widely spread network traffic parameters and indistinctive patterns to hide attacker identities and render mitigation challenges.

According to the disclosed embodiments, the defense system 130 is configured to discover a pattern and/or target parameters based on behavioral analyses of the network telemetry data of the attack that is collected at the defense system 130. In addition to telemetry data of the attack, telemetry data of peacetime (when no attack is detected) are utilized for the behavioral analysis. In an embodiment, the defense system 130 receives the telemetry data of peacetime from the telemetry system 120 distributed across the protected entity's 160 network infrastructure. Such data may be received directly, over the network 110, or both. In another embodiment, the telemetry data of peacetime may be retrieved from the database 150. The telemetry data of peacetime may be, for example, but not limited to, raw collected data, processed data, and the like, and any combination thereof. In an embodiment, the behavioral data determined through the behavioral analysis are represented in an influence matrix.

According to the disclosed embodiments, the detected attack is classified into a pattern category that is leveraged for determining the target traffic parameters for mitigation. In an embodiment, a real-time signature (RTS) is automatically generated by selecting one or more target traffic parameters determined from the behavioral analyses of the attack. It should be noted that the pattern category suggests an attack pattern for the DoS/DDoS attack that may otherwise have indistinctive patterns due to its attack nature. It should be further noted that the target traffic parameters in the RTS are determined with improved accuracy, minimizing false positives (e.g., parameters with very low estimated false positive rates) by recognition of the attack pattern. The defense system 130 is configured to characterize the detected attack as a pattern category and an RTS based on its network behavior without disrupting the whole traffic towards the protected entity 160.

In an embodiment, the classification of the attack into a pattern category is based on a plurality of rules that is defined by, for example, weights, scores, rankings, range, and the like, of certain parameters such as, but not limited to, traffic parameters, behavior data, and the like associated with the detected attack. The set of rules includes specific guidelines indicating how to determine a category pattern in relation to the traffic parameters (e.g., footprint values, footprint types, hit rates, etc.), behavioral data (e.g., a distribution of footprint values, verification statuses, cumulated intensities of footprint values and/or footprint types, intensity scale of the footprint type relative to an attack rate, a cumulation of intensity scales, etc.), and the like, and any combination thereof. As an example, the set of rules may indicate a higher priority to certain parameters or a group of parameters over others. In an embodiment, the plurality of rules gives a larger weight to the sum of intensity scales of the footprint types over other behavioral data of the detected attack. In some embodiments, the classification may be based on at least one algorithm, such as a machine learning algorithm, and more.

In a further embodiment, the defense system 130 is configured to generate the RTS including one or more target traffic parameters for effective mitigation. The target traffic parameter in the RTS is a footprint value determined to be involved in the detected attack. At least one mitigation action is performed based on the RTS to effectively address the detected attack. Some example mitigation actions may include, without limitation, blocking network packets, controlling access to network elements (e.g., on routers, firewalls, telemetry systems, and the like), configuring firewall or other network elements, redirecting transactions, and the like, and any combination thereof. It should be noted that the RTS is generated in real-time as the attack is detected at the infrastructure for immediate mitigation against the attack to minimize the risk and damage. It should be further noted that the RTS allows targeted mitigation to reduce false positives (e.g., incorrectly identified legitimate traffic as a threat) that disrupt the normal network traffic. The targeted mitigation, based on the RTS, limits processing to the selected footprint values thereby conserving computing power and memory.

In some implementations, a separate detection system (not shown) may be deployed that detects the attack and notifies the defense system 130. In such a scenario, the detection system receives an attack detection to be characterized.

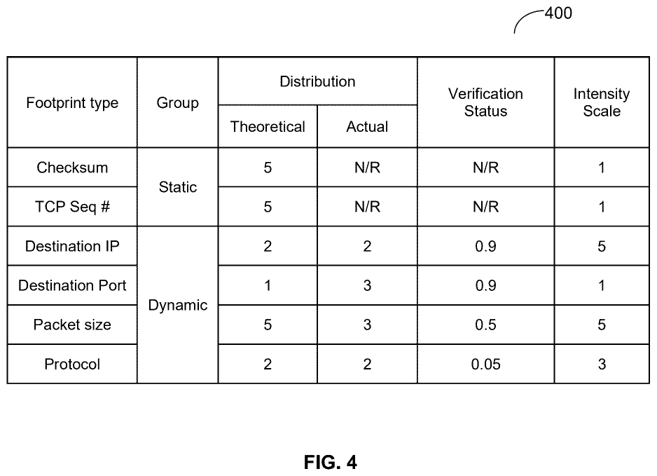

The database 150 such as, but not limited to, data repositories or databases may be communicatively or directly connected to the defense system 130 and the telemetry system 120. The database 150 stores network information such as, but not limited to, traffic parameters (e.g., traffic baselines, footprint types, associated footprint values, hit-rate, etc.), behavioral data, real-time signature (RTS), and the like that are collected and determined during peacetimes as well during attack times. Such network information is determined based on the telemetry systems 120, defense systems 130, or both. In an embodiment, the network information during peacetime and attack time may be arranged in an influence matrix and stored at the database 150. The influence matrix accurately and concisely represents the behavioral data that are relevant and significant to the attack. That is, the influence matrix may reflect portions of the traffic parameters detected from the attack traffic in a relatively small data size. In an embodiment, the influence matrix may reflect behavioral data based on candidate footprint values selected from all footprint values in the telemetry data. In a further embodiment, the peacetime behavioral data may simply be retrieved and commonly applied to multiple attack traffics within a predefined time period, for example, to refresh and/or update the peacetime behavioral data. An example influence matrix is shown in FIG. 4.

In an embodiment, the network information of the attacks that are collected and analyzed by the defense system 130 are stored in the database 150. Such attack-related network information may be stored as part of a threat intelligence of the protected entity's 160 network infrastructure. The cybersecurity threats stored in the database 150 may be, for example, periodically updated to store up-to-date information with respect to various threats and/or attacks including, but not limited to, network layer targeting attacks, botnet-originated attacks, and more.

Moreover, the database 150 stores network information collected and analyzed during peacetime including, but not limited to, peacetime traffic parameters (e.g., peacetime network baseline, footprint types, footprint values, etc.), behavioral data (e.g., distributions of traffic parameters, rate-based parameters, hit rate, and the like, and their derivatives), and the like. The telemetry data during peacetime may be gathered by the telemetry systems 120 and provided to the defense system 130 and/or the database 150. Such telemetry data are relayed intermittently, periodically, on-demand, and the like, and any combination thereof. As an example, the telemetry data are provided at predefined intervals of 1 or 2 minutes.

In an embodiment, the defense system 130 may process the telemetry data to generate peacetime traffic parameters, behavioral data, and the like to be stored in the database 150. In another embodiment, the processing of telemetry data to generate peacetime network information may be performed at the telemetry system 120. As noted above, the peacetime and attack time network information may be stored as parts of the influence matrix.

The peacetime network information including, for example, but not limited to, verification statuses (i.e., citizenship level), distribution of footprint values, a scale of the distribution, and the like, may be readily and rapidly retrieved from the database 150 for behavioral analysis of attack period traffic. It should be further noted that such availability supports real-time behavioral analysis and automatic RTS generation for real-time mitigation of the attack. The shared peacetime network information between different attacks toward the same protected entity infrastructure reduces the amount of processing, and the amount of stored data, thereby conserving computational resources (e.g., processing power, memory space, and the like) at the defense system 130 and the infrastructure as a whole. In addition, communication and transmission of data between components may also be reduced. In an example embodiment, the peacetime network information may be refreshed or updated at predefined time intervals, for example, every hour.

The protected entity 160 may be a network entity (e.g., routers, firewalls, etc.), a server, an application, a service, and the like, and a target for the attacker devices 140. Some examples of protected entity 160 include, without limitation, a range of IP addresses, network elements, service elements, and the like, and any combination thereof. Moreover, the protected entity 160 communicates with the example components shown in FIG. 1 over any type of network 110.

According to the disclosed embodiments, the defense system 130 is configured to selectively mitigate the detected attack from the traffic based on the attack-specific RTS so that non-malicious and legitimate network traffic such as, but not limited to, transactions, packets, or the like, may reach the protected entity 160 without disruption. To this end, the disclosed embodiments reduce the computational burden and improve computational efficiency.

In some configurations, the defense system 130, telemetry system 120, and/or the protected entities 160 may be deployed in a cloud computing platform and/or in an on-premises deployment, such that they collocate together, or in a combination. The cloud computing platform may be, but is not limited to, a public cloud, a private cloud, or a hybrid cloud. Examples of cloud computing platforms include Amazon® Web Services (AWS), Cisco® Metacloud, Microsoft® Azure®, Google® Cloud Platform, Cisco® Metacloud, and the like which offer shared infrastructure managed by the cloud provider, providing scalability, flexibility, and reduced infrastructure management. On-premises deployment involves the defense system 130 on the organization's own servers and infrastructure, giving the organization complete control over the environment but also requiring more management and maintenance effort. This option is often chosen for systems with strict security or compliance requirements.

It should be noted that the arrangement of components as illustrated in the example network diagram 100 does not limit the scope of the disclosed embodiments. As an example, the defense system 130 may be connected over the network rather than in-line with the protected entity 160. In another example, the defense system 130 and telemetry system 120 may be combined.

It should be noted that although one defense system, telemetry system, and/or database are depicted in FIG. 1, merely for the sake of simplicity, the embodiments disclosed herein can be applied to a plurality of detection systems, telemetry systems and/or databases for protecting a single protect entity, a single network infrastructure, multiple geographically distributed protected entities 160, clients, servers, and the like.

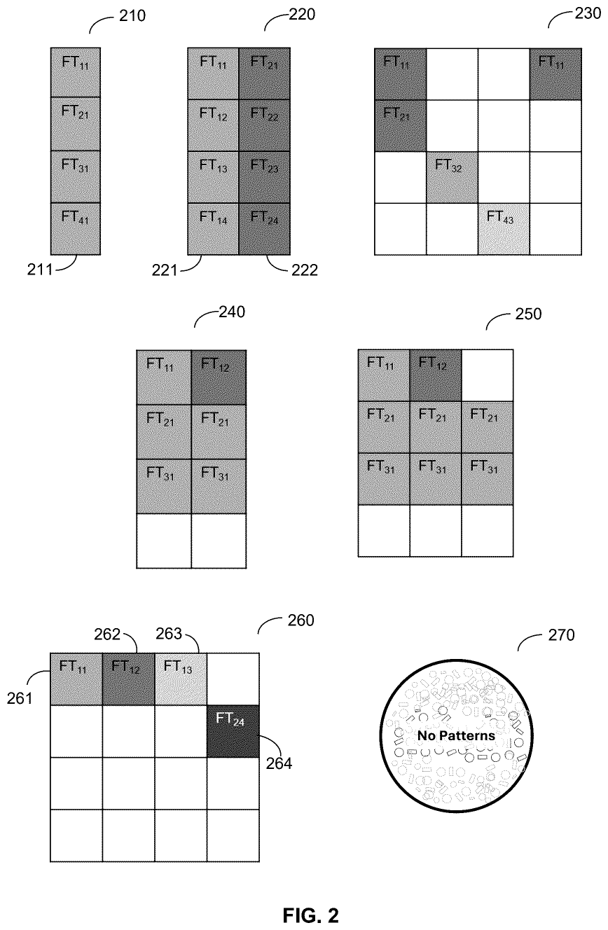

FIG. 2 shows schematic diagrams 210 through 270 illustrating example distribution of traffic parameters representing various pattern categories for an attack. It has been identified that a DoS/DDoS attack involves sending a large volume of network packets with diverse traffic parameters (i.e., footprint types, footprint values, etc.) in order to successfully bypass detection and evade mitigation. The complex and varied nature of such attacks results in indistinctive attack patterns, thereby launching attacks that are not only challenging to detect, but also to effectively mitigate. To this end, current techniques are largely dependent on non-specific defense methods that can cause false positives and false negatives blocking of the network traffic.

According to the disclosed embodiments, DoS/DDoS attacks are characterized through behavioral analysis of the network traffic during attack and peacetime for attack analysis and targeted mitigation. In an embodiment, the characterization includes the classification of the detected attack into a pattern category. The classification is based on a plurality of rules that are applied in relation to the traffic parameters, behavioral data, and the like of the detected attack. The pattern category illustrates the distribution of traffic parameters across the attack network traffic. In an embodiment, the classification depends on the attack time network packets that are collected and analyzed in real-time. In a further embodiment, the classification is determined based on network information (e.g., traffic parameters, behavioral data, etc.) of candidate footprint values that are reoccurring at a rate above a predefined threshold value. The candidate footprint values represent a subset of footprint values of the entire network traffic or footprint types. It should be noted that the categories provide a pattern category that is otherwise not apparent in such distributed attacks. It should be further noted that the pattern category provides a guideline and criteria for identifying footprint types and footprint values that are associated with the detected attack with less computational burned.

In an embodiment, the detected attack may be classified into, for example, but not limited to, an overlap pattern, a partial overlap pattern, a no overlap pattern, and a fully randomized pattern. Some example network distributions for each of the pattern categories are shown in diagrams 210 through 270. It should be noted that these distributions are examples presented for illustrative purposes and do not limit the scope of the disclosed embodiments.

Examples of network packet distributions for each pattern category are shown as grids with each vertical column representing a network packet in the attack traffic. In the examples, each packet has four footprint types, represented as a row, and a footprint value in each box represented as FTₜᵥ, where t represents a footprint type and v represents a footprint value.

An attack may be classified as the overlap pattern categories 210 and 220 when identical packet 211 or packets 221 and 222 are repeatedly observed in the attack traffic. The overlap pattern category may be further distinguished between a fully overlap pattern 210 that has a single repeating packet and the overlap pattern 220 that has a few repeating packets that are identical. The partial overlap pattern category 230 through 250 may include packets that share at least one common footprint value but are not identical to one another. The no overlap pattern category 260 may include network packets without common footprint values but have footprint values 261 through 264 that are repeating in the traffic. The fully randomized pattern category 270 may be identified for an attack traffic that is widely distributed without notable distinctions or footprint values based on, for example, but not limited to, intensity (i.e., hit rate of footprint values). It should be noted that the shaded boxes with footprint values (e.g., FT₁₁, FT₁₂, etc.) represent footprint values that are detected repeatedly and have hit rates above a predefined threshold value. In an embodiment, such footprint values may be referred to as a candidate footprint value. In a further embodiment, the candidate footprint values are extracted and analyzed to determine the behavioral data of the attack.

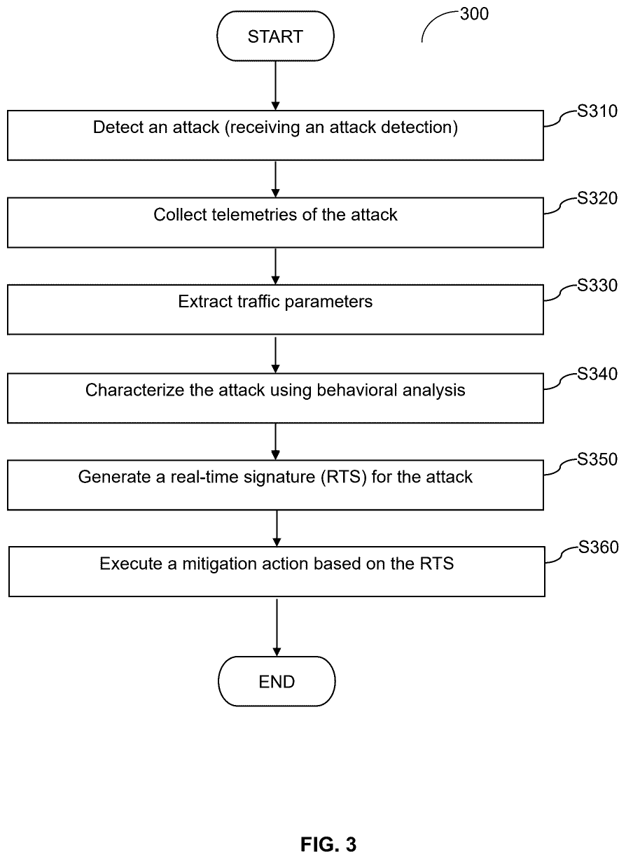

In an embodiment, the detected attack may be classified according to the behavioral data such as, but not limited to, an intensity scale of a footprint type, a cumulated intensity scale of all footprint types, and the like of the detected attack and the plurality of rules defining criteria and guidelines. An intensity scale of a footprint type is defined as a numerical score, for example, between 1 and 5, that indicates a total hit rate of footprint values within the footprint type with respect to an attack rate of the detected attack. A cumulated intensity scale of all footprint types is defined as a sum of intensity scales determined for all footprint types of the detected attack. It should be noted that the classification depends on the traffic parameters and their behavioral data from the attack time traffic. It should be further noted that the intensity (e.g., the hit rate) and its derivatives of footprint values indicate variations between footprint types and the attack pattern. The method of characterizing the detected attack is further described below in FIG. 3-5.

FIG. 3 is an example flowchart 300 illustrating a method for characterizing and mitigating a DDoS network attack according to an embodiment. The described method is performed at a defense system 130, FIG. 1 that reads incoming traffic including the attack traffic. In an embodiment, the defense system 130 is in-line with a protected entity 160, FIG. 1.

The method is described with respect to a single attack for simplicity and does not limit the embodiments disclosed herein. The method may be performed simultaneously for multiple attacks targeting the protected entity 160, FIG. 1, for example, simultaneously. It should be noted that the operation from attack detection to execution of at least one mitigation action occurs in near real-time or at real-time to effectively mitigate and minimize damage at the protected entity 160 and/or the whole network infrastructure.

At S310, an attack is detected. The attack is a cybersecurity attack causing denial of service (DoS), distributed denial of service (DDoS), or the like against a protected entity (e.g., the protected entity 160, FIG. 1). Such an attack may be carried on at least one of layers 3 to 5 of the Open System Interconnection (OSI) reference model. Some examples of a DDoS attack on the network layer include, but are not limited to, SYN flood, UDP flood, ICMP flood, amplification attacks, Smurf attack, and the like. As an example, the attack is identified from a specific incident within the network environment. In another example, the attack may be a detected based on a deviation from baseline traffic pattern.

In an embodiment, the attack may be detected by the defense system (e.g., the defense system 130, FIG. 1). In another embodiment, the attack may be detected by one or more telemetry systems (e.g., the telemetry system 120, FIG. 1) and relayed to the defense system (e.g., the defense system 130, FIG. 1). In yet another embodiment, a separate detection system may detect the attack and notify the defense system. It should be noted that the cybersecurity attack employs unpredictable and or randomized patterns to evade detection from conventional security mechanisms and to overwhelm the protected entity.

At S320, telemetry data of the attack are collected. The telemetry data may include network telemetry, system telemetry, application telemetry, security telemetry, endpoint telemetry, and the like. Some examples of telemetry data include, without limitation, packet-level network data, flow metrics, device health, application performance, and the like. In particular, the network telemetry including network traffic towards the protected entity is collected, which includes, for example, but not limited to, packet counts, packet size, protocol types, source IP address, destination IP address, flow data, and the like, and more. The protected entity may be, for example, but not limited to, a network element, a range of IP addresses, service elements, and the like, and any combination thereof.

In an embodiment, the telemetry data of the attack are collected by the defense system (e.g., the defense system 130, FIG. 1) for continuous monitoring of network traffic in the protected entity's network environment. In some embodiments, the telemetry data is received from one or more telemetry systems (e.g., the telemetry system 120, FIG. 1), or their sensors, that are distributed over the network. In some other implementations, the telemetry data may be collected from the database (e.g., the database 150, FIG. 1). In an embodiment, the telemetry data of the attack are collected in real-time as the attack occurs. In an example embodiment, the telemetry data of the attack may be collected for a predefined time window. In another embodiment, the telemetry data of the attack may be collected periodically within the duration of the detected attack.

At S330, traffic parameters are extracted from the telemetry data. The traffic parameters include at least one value (i.e., footprint value) for each of a plurality of footprint types employed in the detected attack. In addition, the traffic parameters include an intensity (i.e., a hit rate) for each of the at least one footprint value. In an embodiment, the traffic parameters are extracted from the network packets received during the on-going detected attack. The plurality of footprint types is a predefined subset of network telemetry types such as, but not limited to, checksum, Transmission Control Protocol (TCP) sequence number, packet identifier (ID), destination Internet protocol (IP), destination port, packet size, Time to Live (TTL), L3 protocol type, source IP, Type of Service (ToS), fragment offset, message type, and the like. As an example, the traffic parameters include five different destination IP addresses and their intensities for the destination IP footprint type that are extracted from the attack telemetry data. In an embodiment, the extracted traffic parameters may be represented and stored as a footprint matrix of footprint values as shown below:

$$Footprint matrix = [ \begin{matrix}FT 11 & FT 12 & FT 13 & … & FT 1 v \\ FT 21 & FT 22 & FT 23 & … & FT 2 v \\ FT 31 & FT 32 & FT 33 & … & FT 3 v \\ ⋮ & ⋮ & ⋮ & ⋱ & ⋮ \\ FTt 1 & FTt 2 & FTt 3 & … & FTtv\end{matrix} ] \qquad ( 1 )$$

Herein, each FTₜᵥ is a footprint value, v, within a footprint type, t. The footprint matrix represents footprint values for different footprint types in rows and different packets in columns. It should be noted that the footprint values may be identical between different packets. As an example, when network packets 1, 2, and 4 are identical in packet size, which is footprint type 1, the footprint values FT₁₁, FT₁₂, and FT₁₄, have the same values.

It should be noted that the predefined subset of network telemetries (i.e., predefined subset of footprint types) extracted for the traffic parameters may be employed for characterizing the attack and adding to the real-time signature (RTS). It should be further noted that the selected subset, that is a smaller selection of relevant telemetry data, reduces the data size for reduced computational load and time for accurate and efficient characterization and mitigation of the attack that is particularly desired for on-going cybersecurity attacks and real-time mitigation.

In an embodiment, a footprint value that reoccurs multiple times in the detected attack above a predefined threshold value (e.g., number of times, percentage, proportion, rate, or the like) may be referred to as a candidate footprint value. It should be note that the predefined threshold value may be adaptively defined, meaning that the predefined threshold value may be updated with changes in the normal peacetime traffic rate. As an example, the predefined threshold value may be updated in time intervals of, for example and without limitation, one hour, few hours, 24 hours, or the like. The candidate footprint values are a subset of traffic parameters of the entire attack traffic. In an embodiment, the candidate footprint values are utilized for characterization of the detected attack. In a further embodiment, such candidate footprint values may be utilized in refining the RTS as described herein below.

At S340, the detected attack is characterized by applying behavioral analysis to the extracted traffic parameters. The characterization involves determining behavioral data indicating attack patterns as well as prioritizing footprint types based on the behavioral analysis. In an embodiment, the detected attack is classified into a pattern category from the pattern categories described above in FIG. 2. In an example embodiment, the pattern categories may include, but are not limited to, an overlap pattern, a partial overlap pattern, a no overlap pattern, and a fully randomized pattern.

In an embodiment, behavioral data such as, but not limited to, an intensity (or hit rate), a total intensity of footprint values, the total intensity with respect to the attack rate (i.e., an intensity scale), a verification status, and the like, and any combination thereof are determined for each of the plurality of footprint types and their values to characterize the detected attack. The behavioral data represents the attack traffic profile on account of, for example, but not limited to, load, structure, composition, identity, and the like from rate-variant and rate-invariant parameters of the detected attack traffic. In a further embodiment, the behavioral data is utilized to classify the attack into the pattern category. The total intensity of footprint values for all values within a footprint type is compared to the detected attack rate to determine the intensity scale of the footprint type. In an example embodiment, the intensity of footprint values and footprint types as well as their derivatives such as, but not limited to, the intensity scale, a sum of the intensity scale, and the like, may be employed for identifying the pattern category.

A verification status (or citizenship) of a footprint value indicates repeated detection of the footprint value during peacetime without security threat or interruption. Such verified footprint value may be regarded as being trusted and likely a legitimate packet. In an embodiment, the verification status of a specific footprint type in the behavioral data may be defined as, for example, but not limited to, Boolean data, a score indicating a verification level (also referred to as a ‘citizenship level’), or the like of the entire footprint type based on the verification status of the footprint values associated with the specific footprint type.

The verification status (e.g., Boolean, score, etc.) defines a trust level of the footprint type and is determined based on a proportion of verified footprint values out of all footprint values in the footprint type. The Boolean-based verification status may be determined by comparing the proportion to a predefined verification threshold value. As an example, a footprint type is labeled as “Yes” verification status upon determining a proportion of verified footprint values above a predefined verification threshold value, for example, 0.6.

In an embodiment, the verification status of the footprint type may be determined from a subset of footprint values of the footprint type that excludes verified, trusted footprint values. In an example embodiment, verified footprint values that have relatively high verification score and low impact on the footprint type's intensity scale are removed from a set of footprint values for the footprint type in order to create the subset of footprint values of the footprint type. As an example, the verified footprint value has a verification score above a predefined verification threshold value. It should be noted that such subset and its verification status eliminate bias from verified footprint types to increase accuracy of the verification status, characterization, and in return, effective and efficient mitigation of the detected attack.

In a further embodiment, the behavioral data may be determined during the peacetime to account for a distribution of footprint values in the protected entity. It should be noted that the verification statuses and the distribution of footprint values with respect to footprint types are determined during peacetime and may be referred to as peacetime behavioral data. In an embodiment, the peacetime behavioral data is determined during low traffic periods from sampled portion of the traffic and commonly represent the normal traffic during a predefined time interval. To this end, the determining and storing of the peacetime behavioral data are performed while conserving computational resources, specifically, in processing power and memory. In an embodiment, such behavioral data may be determined using telemetry data collected at the telemetry system (e.g., the telemetry system 120, FIG. 1) during peacetime when no attack is detected in the network traffic. The peacetime behavioral data may be determined at the telemetry system, the defense system, or both. In some implementations, the peacetime telemetry data that are collected and/or processed as behavioral data may be stored at the database (e.g., the database 150, FIG. 1).

In some embodiments, the behavioral data are represented in an influence matrix and stored in a memory and/or database (e.g., the database 150, FIG. 1). An example influence matrix 400 is shown in FIG. 4. The example influence matrix 400 includes the plurality of footprint types, corresponding groups, and the behavioral data (e.g., a distribution of footprint values, an intensity scale with respect to the attack rate, a verification status, and the like) for each of the plurality of footprint types.

In an embodiment, the behavioral data are utilized to generate a priority list of the plurality of footprint types. The priority list prioritizes certain footprint types over other footprint types based on at least priority scores determined from a plurality of priority rules. The priority list ranks the plurality of footprint types from highest to lowest priority. In an example embodiment, the footprint type is prioritized initially based on its clustered group and followed by its priority score rank within the group. The footprint type may belong to any one of: a static group, a dynamic non-verified group (i.e., a non-citizen group), and a dynamic verified group (i.e., a citizen group), which are introduced and sorted from highest priority to lowest priority. In an embodiment, the footprint types that belong to each group are predefined. In a further embodiment, the groups are defined by an estimated probability of the footprint type repeating within the attack. As an example, a footprint type with low reoccurrence probability would be associated with a static group, while a footprint type with high reoccurrence probability would be defined in the dynamic group.

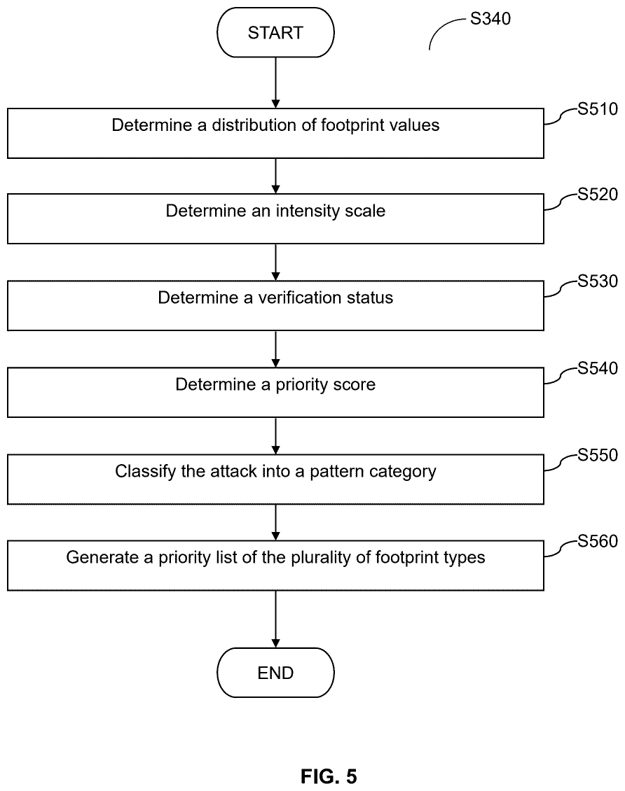

It should be noted that the prioritized footprint types display stronger and/or consistent behavioral patterns (e.g., intensity scale, narrow distribution, and the like) than less priority footprint types. Additionally, it should be noted that the prioritized footprint types display consistent patterns that didn't appear, or at relatively low intensity, during peacetime, thereby representing attack patterns that does not match a legitimate traffic pattern. It should be further noted that such a priority list is utilized for characterizing the detected attack. The behavioral analysis for attack characterization is further described in FIG. 5.

At S350, a real-time signature (RTS) is generated for the detected attack. In an embodiment, the RTS includes a footprint type and associated footprint values employed in the detected attack. The RTS identifies the footprint type and its values as the target for effective mitigation. As an example, when a footprint type is a destination port, all destination port values identified in the telemetry data of the detected attack (S310) are added to the RTS for targeting. It should be noted that the RTS is a unique signature for the detected attack with respect to the protected entity. In an embodiment, the RTS includes one or more footprint types and associated values that are determined based on the characterization. It should be noted that the RTS includes selective footprint types and values (i.e., target traffic parameters) identified to be attack-relevant and targeted. It should be further noted that the RTS includes a portion of the footprint types and values extracted for the detected attack for targeting and mitigation, thereby conserving computational resources such as, but not limited to, memory space, computing power, and the like.

The footprint type for the RTS is selected from the priority list of the plurality of footprint types that characterizes the detected attack. In an embodiment, the footprint type is sequentially selected and added to the RTS through repeated operations of adding a footprint type to an RTS and executing a mitigation action based on the RTS, for example by repeating S350 and S360. Here, closed-loop feedback from the mitigation is utilized to select the footprint types for the RTS. A first footprint type that is a top-ranked footprint type with the highest priority in the priority list (S340) is selected and added to the RTS. Subsequent footprint types in the priority list may be added according to the order in the priority list. As noted above, the priority for the footprint type is determined based on at least a priority score and a group of the footprint type.

In an embodiment, the RTS generated for the detected attack may be stored in a database (e.g., the database 150, FIG. 1). In a further embodiment, the RTS stored in the database may be used as input for threat intelligence for the protected entity (e.g., the protected entity 160, FIG. 1), its network infrastructure, all related client network, or for the public.

According to the embodiments disclosed, a closed-feedback loop may be performed based on the mitigation action using the RTS. A feedback on the effectiveness of the executed mitigation is received to iteratively add additional footprint types and values according to the priority list (S340). In an embodiment, upon receiving a negative feedback indicating ineffective mitigation of the detected attack, the operation returns to the priority list of the attack to select a second footprint type that is next in priority rank after the first footprint type. Then, the operation continues to execute a mitigation using the RTS with the first footprint values and the second footprint values. Such closed-feedback loop may continue until a positive feedback indicating normalization of the traffic to a normal baseline network traffic rate is received. In an embodiment, the footprint types are sequentially added to the RTS with an “OR” relationship. It should be appreciated that the closed-feedback loop enables incremental targeting of footprint values that conserve computing resources.

Further, according to the embodiments disclosed, the RTS generated using the above closed-feedback loop may be further refined by adding candidate footprint values to the RTS generated using the closed-feedback loop based on the priority list. As noted above, the candidate footprint values are footprint values that are collected above a predefined threshold value in the detected attack. In an embodiment, a closed-feedback loop may be performed to incrementally add a candidate footprint value until a positive feedback is received or exhaustion of the candidate footprint values. It should be noted that the process of refining the RTS may reduce the number of footprint values of the RTS for reduced data size. Moreover, the refined RTS improves the accuracy of the RTS and mitigation using the RTS by incorporating candidate footprint values that are collected with high intensity above the predefined threshold value during the detected attack. In an example embodiment, the candidate footprint values are successively added using an “AND” relationship, thereby limiting the RTS to a smaller set of target footprint values with greater presence and impact in the detected attack. It should be noted that the refined RTS targets a smaller subset of packets with specificity, thereby preventing the blocking of legitimate network traffic. That is, the refined RTS further enhances accuracy and reduces false positives in characterizing and mitigating traffic toward the protected entity.

In some embodiments, the mitigation action is executed based on the RTS generated and/or refined according to the closed-feedback loop. It should be noted that the mitigation based on the RTS allows broad attack coverage with improved accuracy. That is, false positive mitigation of legitimate traffic is reduced.

In an embodiment, the steps of FIG. 3 may be performed in a state machine. The state machine includes multiple states such as, but not limited to, a footprint type identification, an attack characterization, an RTS generation, an RTS refinement, and a mitigation that are sequentially performed for mitigating the detected attack and protecting the protected entity and its network infrastructure.

At S360, a mitigation action is executed based on the RTS. The footprint values of the footprint type in the RTS are targeted for mitigation. In an embodiment, the mitigation action may be, for example, but not limited to, blocking network packets, access control (e.g., on routers, firewalls, telemetry system, etc.), configuring the firewall or other network elements, redirecting transactions, and the like, and any combination thereof. In a further embodiment, the mitigation action may involve generating and/or sending a notification to a protected entity (e.g., the protected entity 160, FIG. 1) or a user device associated with the protected entity (not shown). As an example, the notification is an alert that may include information on the detected attack. It should be noted that the mitigation action is executed to target the certain footprint values in the generated RTS for accurate and effective mitigation of the detected attack. One of ordinary skill in the art would understand that the targeted mitigation improves accuracy in mitigating the detected attack with reduced false positives and disruption of normal network traffic. Moreover, the time and computing power to mitigate the detected attack would be minimized.

FIG. 4 is an example influence matrix 400 having the behavioral data according to an example embodiment. The example influence matrix 400 lists behavioral data for footprint types checksum, TCP sequence, destination IP, destination port, packet size, and a protocol. The behavioral data are represented numerically where appropriate and N/R where such behavioral data is non-relevant.

In an example embodiment, the theoretical and actual distributions are defined as an integer between 1 and 5 indicating narrow and wide distributions, respectively. The intensity scale is represented as an integer between 1 and 5 indicating weak and strong matches, respectively, to the detected attack rate. Moreover, the verification status may be a number between 0 and 1 where 0 represents a non-verified footprint type and 1 represents a fully verified footprint type. In an example embodiment, 0 and 1 may be used for Boolean representations of the verification status of non-verified and verified footprint types, respectively. It should be noted that the example influence matrix 400 does not limit the scope of the disclosed embodiments. The influence matrix may include other footprint types and may be arranged difference without departing the scope of the disclosed embodiments.

As noted above, some parts of the influence matrix such as, but not limited to, the theoretical distribution, the actual distribution, the verification status, and the like, represent normal traffic during peacetime and thus, determined during peacetime when no attack is detected. Such peacetime behavioral data are not constantly changing. In an embodiment, peacetime parts of the influence matrix may be stored and retrieved from the database and employed without further analysis during attack time.

FIG. 5 is an example flowchart S340 illustrating a method for attack characterization by applying a behavioral analysis according to an embodiment. The method described herein may be performed at the defense system 130, FIG. 1. In an embodiment, the behavioral analysis of peacetime traffic, when an anomaly or attack is not identified, may be performed at the telemetry system 120, FIG. 1.

At S510, an actual distribution of footprint values is determined for each footprint type. The actual distribution defines a degree of variation in footprint values observed during peacetime in the network environment of the protected entity (e.g., the protected entity 160, FIG. 1). In an embodiment, the actual distribution is determined from telemetry data that are collected and relayed by one or more telemetry systems during the peacetime, when no attack or threat is evoked on the protected entities (e.g., the protected entity 160, FIG. 1). In an example embodiment, the distribution is represented as an integer from 1 to 5 suggesting a narrow to a wide variation of footprint values, respectively. It should be noted that the actual distribution is a specified distribution determined and common for the specific network environment.

Other network environments may have different actual distributions based on their network-specific telemetry data.

In an embodiment, a divergence of the actual distribution from a theoretical distribution is determined. The theoretical distribution is an a-priori estimation of footprint value variations from probability factors that are known for each footprint type and thus, does not account for the specific network environment. In an example embodiment, the theoretical distribution may also be represented as an integer from 1 to 5 for comparison with the actual distribution. In an embodiment, the divergence indicates a distance and a direction of the actual distribution from the theoretical distribution.

In an embodiment, the actual distribution and the divergence may be updated periodically after a predefined time period to represent the most current state of the network environment. In an example embodiment, the actual distribution and its divergences from the theoretical distribution may be determined, for example, periodically, upon initiation, or the like during peacetime. As an example, such data is updated and stored every hour. In some embodiments, the actual distributions and the divergences of the plurality of footprint types may be retrieved from, for example, a memory and/or database (e.g., the database 150, FIG. 1) for the associated network environment. In such a scenario, the process of determining the distributions and divergences may be omitted.

At S520, an intensity scale is determined for each footprint type in the detected attack. The intensity scale is a numerical representation of the total accumulated intensity (i.e., a sum of hit rates) of the footprint values within each footprint type with respect to an overall attack rate. The overall attack rate is the rate at which the attack traffic towards the protected entity is observed, for example, at the defense system. In some implementations, the attack traffic including the overall attack rate, intensity value (e.g., hit rate), and the like are received from the telemetry system. In an example embodiment, the intensity scale of the footprint type is an integer from 1 to 5 indicating a lowest relative total intensity to a highest relative total intensity, with respect to the attack rate, respectively. As an example, an intensity scale of 1 for a packet size footprint type suggests that the relative total intensity, a sum of the footprint value intensities, of the packet size footprint type is significantly lower than the overall attack rate of the detected attack.

At S530, a verification status (or a citizenship) is determined for each footprint type. The verification status is determined by a ratio (or a proportion) of verification statuses of all footprint values extracted from the attack and within the footprint type. A verification status of a footprint value is predetermined based on a repeated detection of the footprint value during peacetime and stored in a memory and/or a database. In an embodiment, the verification status is defined as a Boolean data type (e.g., Yes or No, 1 or 0, etc.). As an example, a footprint type with 7 footprint values having verification statuses out of 10 total footprint values is also determined to have the verification status. On the contrary example, a second footprint type with 2 footprint values with verification status out of 12 total footprint values is determined not to have the verification status. In another embodiment, the verification status may be defined as a verification score, for example, between 0 and 1. The verification status of the footprint type, whether a Boolean, a score, or any other format, is determined based on the verification status of each footprint value in the footprint type.

In an embodiment, the verification status is determined for a subset of footprint values associated with the footprint type. The footprint values for the subset are selected by eliminating verified footprint values within the footprint type. That is, footprint values that are verified as being a trusted or legitimate traffic are removed as a potential footprint value for the RTS and target for mitigation. The subset of footprint values is missing the verified footprint values. In an example embodiment, the footprint values with a high verification score and do not reduce the total intensity of the footprint type are removed and not part of the subset of footprint values. In such a scenario, the subset of footprint values is employed for the succeeding steps to characterize the detected attack, for example, but not limited to, for the verification status of the footprint type, a priority score, an attack pattern, a priority list, and the like as well as the generation of the RTS.

At S540, a priority score is determined for each footprint type. The priority score is determined based on an initial priority score and a derivative of the distribution divergence for each footprint type. The initial priority score is a theoretical estimate of priority based on known probability factors as determined for the theoretical distribution. In an example embodiment, the priority score is determined by comparing the derivative of the distribution divergence from the initial priority score. In an embodiment, the priority scores of the plurality of footprint types may be stored and retrieved from a memory and/or database (e.g., the database 150, FIG. 1) within the predefined time period as noted in for determination of a distribution (S510). It should be noted that at least the priority score is utilized in generating a priority list that ranks the footprint types at S560.

At S550, the detected attack is classified into a pattern category. In an embodiment, the pattern category is a category from the four pattern categories described in FIG. 2. In an embodiment, the four categories include, an overlap pattern, a partial overlap pattern, a no overlap pattern, and a fully randomized pattern. In an embodiment, the attack is classified based on a comparison of the total intensity (hit rate) of footprint values against the overall attack value. In some embodiments, the intensity scale may be utilized for classification. It should be noted that the intensity and its derivatives (e.g., intensity scale, sum of intensity scales, etc.) represent the footprint types in the detected attack. As an example, an overlap pattern attack would have footprint types with similar intensities. In another example, a partial overlap attack and a no overlap attack would be varies intensities among footprint types.

Upon classification of the detected attack as a fully randomized pattern category, the operation continues to a mitigation process based on, for example, the verification statuses. Otherwise, for all other pattern categories, operation continues to S560 to identify prioritized footprint types to further characterize and effectively mitigate the detected attack.

It should be noted that the process of determining various behavioral data of the attack described in steps S510 through S550 is introduced sequentially for teaching purposes and does not limit the scope of the disclosed embodiments. The determining steps may be performed in any order. In some embodiments, the steps may be performed simultaneously. In an embodiment, the behavioral data for the detected attack may be stored as an influence matrix having the behavioral data, priority scores, the plurality of footprint types, group labels, and the like, and any combination thereof. An example influence matrix 400 is shown above in FIG. 4.

At S560, a priority list is generated for the detected attack. In an embodiment, the priority list ranks footprint types in a static group on top to have the highest priority followed by a dynamic non-verified group, and a dynamic verified group. In a further embodiment, within each group, the footprint types are ranked from highest priority score, within the group, to the lowest priority score, within the group. That is, a first footprint type with a highest priority score in a dynamic verified group would be ranked at the top of its group, but after all footprint types of the static group and the dynamic non-verified group are listed in the priority list.

In an embodiment, the ranking of footprint types, within the group, may differ based on the pattern category of the detected attack (8550). That is, the generation of the priority list is performed based on a priority rule that defines weights, bias, or the like, on one or more behavioral data (e.g., the distribution, the intensity scale, the verification status, the pattern category, etc.). In an example embodiment, footprint types for a detected attack in a full overlap category are sorted according to the priority score values. In a further example embodiment, footprint types for an attack in a partial overlap category or a no overlap category are sorted first according to the intensity scales, then by the priority scores. It should be noted that sorting is performed within each grouping of the footprint types as noted above.

In an embodiment, the footprint types are grouped as a static group or a dynamic group based on an estimated probability of the footprint value repeating within the attack. As an example, a packet checksum changes with each packet, and thus, a packet checksum footprint type is estimated to have a low probability of repeating and clustered in a static group. In another example, a destination port is estimated to have a high probability of repeating, and thus, the destination port footprint type is identified as a dynamic group. In a further embodiment, the footprint types in the dynamic group may be further separated as a dynamic non-verified group and a dynamic verified group based on their respective verification statuses. Some examples of static footprint types that routinely change with a low chance of repeating include, without limitation, checksum, TCP sequence number, packet ID, and the like. Some examples of dynamic footprint types that are predicted to be repeated over time, across packets may include, without limitation, destination IP, packet size, TTL, and the like.

It should be noted that the priority list prioritizes footprint types based on behavioral analysis to identify footprint types with a larger impact on mitigation with respect to breadth and accuracy of targets of mitigation actions. Such prioritization of footprint types enables selecting a minimal set of footprint types and values for rapid assembly of a real-time signature (RTS) of the detected attack. That is, a mitigation targets are accurately and efficiently identified to minimize false positives while ensuring broad coverage for effective attack mitigation. It should be noted that the priority list and prioritization of footprint types are adapted to a specific protected network which allows specified and customized analysis and mitigation.

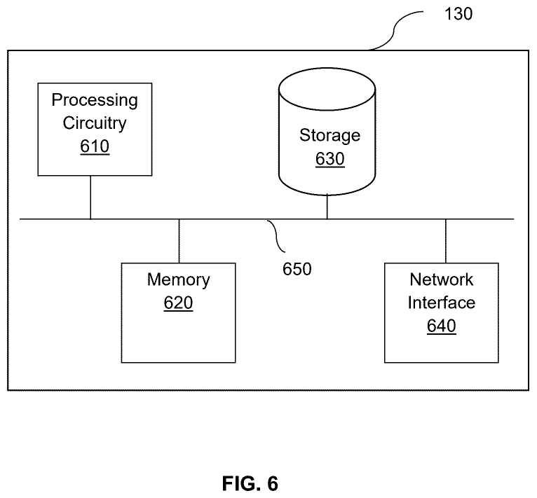

FIG. 6 is an example block diagram of a hardware layer depicting a defense system 130 according to an embodiment. The defense system 130 may be a compute node or a network node and includes a processing circuitry 610 coupled to a memory 620, a storage 630, and a network interface 640. In an embodiment, the components of the defense system 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read-only memory, flash memory, etc.), or a combination thereof.

In one configuration, software for implementing one or more embodiments disclosed herein may be stored in storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or another memory technology, compact disk-read only memory (CD-ROM), Digital Versatile Disks (DVDs), or any other medium which can be used to store the desired information.

The network interface 640 allows the defense system 130 to communicate with the various components, devices, and systems described herein for production code static analysis, as well as other like purposes. The network interface 640 can be a port of the network node.

It should be understood that the embodiments described herein are not limited to the specific architecture illustrated in FIG. 6, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to and executed by a machine comprising any suitable architecture. Preferably, the machine is implemented on a computer platform having hardware such as one or more central processing units (“CPUs”), memory, and input/output interfaces. The computer platform may also include an operating system and microinstruction code. The various processes and functions described herein may be either part of the microinstruction code or part of the application program or any combination thereof, which may be executed by a CPU, whether such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for efficiently characterizing an incoming cybersecurity attack, comprising:
extracting traffic parameters from collected telemetry data of the attack, wherein the traffic parameters include a plurality of footprint types and associated footprint values;
characterizing the attack by a behavioral analysis of the traffic parameters in order to determine behavioral data for the plurality of footprint types and an attack pattern for the attack, wherein the behavioral data has an intensity scale for each footprint type of the plurality of footprint types with respect to an attack rate;
determining, based on the attack pattern and the behavioral data, a priority list of the plurality of footprint types; and
generating a real-time signature (RTS) for mitigation, wherein the RTS has a target footprint type selected according to the priority list.

2. The method of claim 1, further comprising:
executing a mitigation action for the attack based on the generated RTS.

3. The method of claim 1, wherein characterizing further comprises:
classifying the attack as the attack pattern based on the determined intensity scales for the plurality of footprint types and a plurality of rules.

4. The method of claim 3, wherein the attack pattern is any one of: an overlap pattern, a partial overlap pattern, a no overlap pattern, and a fully randomized pattern.

5. The method of claim 1, further comprising:
retrieving a peacetime behavioral data, wherein the peacetime behavioral data is the behavioral data determined from telemetry data during peacetime, wherein the peacetime behavioral data provides a verification status and a distribution of the footprint values within each footprint type.

6. The method of claim 5, wherein determining the priority list further comprises:
determining a priority score for each of the plurality of footprint types, wherein the priority score is determined based on the peacetime behavioral data of each footprint types;
grouping the plurality of footprint types by a predefined list of footprint type groups; and
sorting the plurality of footprint types within the group by the respective priority scores.

7. The method of claim 6, wherein the attack is a partial overlap or a no overlap pattern, further comprising:
sorting the plurality of footprint types by the intensity scale of each footprint type within the grouping.

8. The method of claim 1, wherein the characterizing further comprises:
identifying a verified footprint value from the footprint values within the footprint type of the plurality of footprint types, wherein the verified footprint value has a verification score above a predefined verification threshold value; and
generating a subset of footprint values for the footprint type that is missing the identified verified footprint value, wherein the subset of footprint values is utilized to determine a verification status and the priority list.

9. The method of claim 2, wherein the mitigation action is executed in real-time for the incoming attack.

10. A non-transitory computer-readable medium having stored thereon instructions for causing a processing circuitry to execute a process, the process comprising:
extracting traffic parameters from collected telemetry data of the attack, wherein the traffic parameters include a plurality of footprint types and associated footprint values;
characterizing the attack by a behavioral analysis of the traffic parameters in order to determine behavioral data for the plurality of footprint types and an attack pattern for the attack, wherein the behavioral data has an intensity scale for each footprint type of the plurality of footprint types with respect to an attack rate;
determining, based on the attack pattern and the behavioral data, a priority list of the plurality of footprint types; and
generating a real-time signature (RTS) for mitigation, wherein the RTS has a target footprint type selected according to the priority list.

11. A system for efficiently characterizing an incoming cybersecurity attack comprising:
a processing circuitry; and
a memory, the memory containing instructions that, when executed by the processing circuitry, configure the system to:
extract traffic parameters from collected telemetry data of the attack, wherein the traffic parameters include a plurality of footprint types and associated footprint values;
characterize the attack by a behavioral analysis of the traffic parameters in order to determine behavioral data for the plurality of footprint types and an attack pattern for the attack, wherein the behavioral data has an intensity scale for each footprint type of the plurality of footprint types with respect to an attack rate;
determine, based on the attack pattern and the behavioral data, a priority list of the plurality of footprint types; and
generate a real-time signature (RTS) for mitigation, wherein the RTS has a target footprint type selected according to the priority list.

12. The system of claim 11, wherein the system is further configured to:
execute a mitigation action for the attack based on the generated RTS.

13. The system of claim 11, wherein the system is configured to:
classify the attack as the attack pattern based on the determined intensity scales for the plurality of footprint types and a plurality of rules.

14. The system of claim 13, wherein the attack pattern is any one of: an overlap pattern, a partial overlap pattern, a no overlap pattern, and a fully randomized pattern.

15. The system of claim 11, wherein the system is further configured to:
retrieve a peacetime behavioral data, wherein the peacetime behavioral data is the behavioral data determined from telemetry data during peacetime, wherein the peacetime behavioral data provides a verification status and a distribution of the footprint values within each footprint type.

16. The system of claim 15, wherein the system is further configured to:
determine a priority score for each of the plurality of footprint types, wherein the priority score is determined based on the peacetime behavioral data of each footprint types;
group the plurality of footprint types by a predefined list of footprint type groups; and
sort the plurality of footprint types within the group by the respective priority scores.

17. The system of claim 16, wherein the attack is a partial overlap or a no overlap pattern, wherein the system is further configured to:
sort the plurality of footprint types by the intensity scale of each footprint type within the grouping.

18. The system of claim 11, wherein the system is further configured to:
identify a verified footprint value from the footprint values within the footprint type of the plurality of footprint types, wherein the verified footprint value has a verification score above a predefined verification threshold value; and
generate a subset of footprint values for the footprint type that is missing the identified verified footprint value, wherein the subset of footprint values is utilized to determine a verification status and the priority list.

19. The system of claim 12, wherein the mitigation action is executed in real-time for the incoming attack.
